(19) United States
(12) Patent Application Publication
(10) Pub. No.: US 2012/0167090 A1
(43) Pub. Date: Jun. 28, 2012

(54) HYPERVISOR FOR STARTING A VIRTUAL MACHINE

(75) Inventors: WU YU HUI, BEIJING (CN); RUI XIONG TIAN, BEIJING (CN); QING BO WANG, BEIJING (CN); YANG ZHAO, BEIJING (CN); ZHI LE ZOU, BEIJING (CN)

(73) Assignee: INTERNATIONAL BUSINESS MACHINES CORPORATION, ARMONK, NY (US)

(21) Appl. No.: 13/416,398

(22) Filed: Mar. 9, 2012

Related U.S. Application Data
(63) Continuation of application No. 13/076,624, filed on Mar. 31, 2011.

(30) Foreign Application Priority Data
Mar. 31, 2010 (CN) 201010142080.6

(51) Int. Cl. G06F 9/455

(52) U.S. Cl. 718/1

(57) ABSTRACT

A hypervisor obtains an agent with an obtaining device. A file for implementing an agent of the virtual machine is obtained in response to an instruction to start the virtual machine. An agent replacing device stores the obtained file to a specified location in a file system of the virtual machine. A virtual machine starting device starts the virtual machine.

### REFERENCE TO RELATED APPLICATIONS

The present application is a continuation of U.S. patent application Ser. No. 13/076,624 (Atty. Docket No. CN920100021US1), filed on Mar. 31, 2011, and entitled, “Hypervisor for Starting a Virtual Machine,” which is incorporated herein by reference.

The current application is related to co-owned and co-pending Chinese Patent Application 201010142080.6 filed on Mar. 31, 2010 and entitled METHOD AND APPARATUS OF DYNAMICALLY ENABLING VIRTUAL MACHINE AGENT, which is incorporated herein by reference.

### BACKGROUND

The present invention relates to a technique of virtual machines, and especially to a hypervisor for providing platform virtualization and for starting a virtual machine in therein.

Virtual machine techniques are based on virtualization in which underlying physical hardware is hidden so that a plurality of operation systems can use and share the hardware transparently. This technique is also called platform virtualization. FIG. 1 schematically shows a simple example for the architecture of a computer system that has adopted the virtual machine technique. In the architecture as shown in FIG. 1, platform 101 is the physical hardware of the computer system, and includes one or more physical computers (also called host machines) and their accessory devices. Platform virtualization layer 102 (also called hypervisor or virtual machine monitor (VMM)) provides a software layer for virtualization of the underlying machine to present the virtualized computer hardware to the virtual machine. Hypervisor 102 carries out supervision processes for corresponding virtual machines of the host machine, and serves as a connection between the virtual machines and the external world. Guest operation systems (OS) 103-1 and 103-2 provide virtual execution environments, known as virtual machines (VMs) for applications on the basis of the virtualized hardware.

A virtual machine can be stopped and re-started. When a virtual machine is running, the file system of the virtual machine includes various executable files (for example, guest operation system, agent and application) and data files. When a virtual machine stops running, the file system of the virtual machine can be stored in the file system of the platform virtualization layer in the form of a file. The file system of a virtual machine can exist as a single or as a plurality of files, such as VMDK files adopted in the VMware product from VMware corporation. These stored files are usually called as images or image files of the virtual machine. All the image files of a virtual machine include an operation system, and can include one or more applications, as well as various other software constructs such as agents. For example, a virtual machine may include one or more agents such as virtual machine monitor agent, configuration agent, backup agent, security agent and the like. These agents communicate with one or more external monitor components such as a remote management service. Depending on specific installation configurations, files for implementing agents may be collected in the same image file, or may be distributed in different image files.

After creating and mounting a virtual machine, it is usually required to re-generate the image and mount it to the host machine if agents in the virtual machine are updated.

Generally, a plurality of virtual machines resides on the host machine. Especially in a distributed computing environment, for example, a cloud computing environment, adopting the virtual machine technique, a large number of virtual machines run on the platform virtualization layer. Accordingly, the load for updating the agents deployed in the virtual machine becomes heavy and complex.

### BRIEF SUMMARY

One embodiment of the present invention is a hypervisor for a computer system. The hypervisor comprises a processor programmed to obtain a first file using an agent obtaining device, in order to implement a first agent of a virtual machine in response to a command to start the virtual machine. An agent replacing device stores the obtained first file to a specified location in a virtual machine file system. A virtual machine starting device starts the virtual machine.

One embodiment of the present invention is a method of starting a virtual machine in a hypervisor of a computer system. A first file for implementing a first agent of the virtual machine, with a processor, is obtained in response to a command to start the virtual machine. The obtained first file is stored to a specified memory location in a virtual machine file system. The virtual machine is started.

One embodiment of the present invention is a computer program product for starting a virtual machine in a hypervisor comprises a computer readable storage medium having computer readable program code embodied therewith. Computer readable program code is configured to store the obtained first file, using an agent replacing device, to a specified location in a virtual machine file system. Computer readable program code is configured to store the obtained file in a specified location in a file system of the virtual machine. Computer readable program code is configured to start the virtual machine with a virtual machine starting device.

### BRIEF DESCRIPTION OF THE SEVERAL VIEWS OF THE DRAWINGS

FIG. 1 schematically shows a simple example for the architecture of a computer system adopting the virtual machine technique;

FIG. 2 schematically shows the structure of a computer system according to an embodiment of the present invention;

FIG. 3 is a flow chart showing a method of updating an agent in a virtual machine of a computer system according to an embodiment of the present invention;

FIG. 4 schematically shows the structure of a computer system according to an embodiment of the present invention;

FIG. 5 is a flow chart showing a method of updating an agent in a virtual machine of a computer system according to an embodiment of the present invention; and

FIG. 6 is a block diagram showing the exemplary structure of a physical computer for implementing an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The embodiments of the present invention are below described with reference to the accompanying drawings. It is to be noted that, for purpose of clarity, representations and descriptions about those components and processes known by those skilled in the art but unrelated to the present invention are omitted in the drawings and the description.

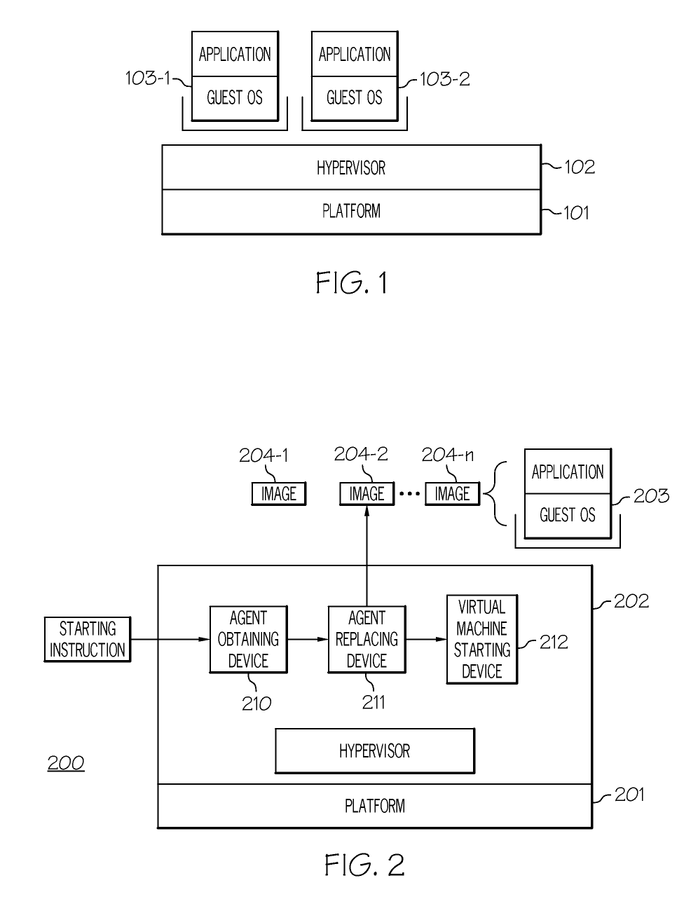

FIG. 2 schematically shows the structure of a computer system 200 according to an embodiment of the present invention. As shown in FIG. 2, the computer system 200 comprises a hypervisor 202 for providing platform virtualization. Further, to facilitate understanding, FIG. 2 also shows a platform 201 of the computer system 200. The platform 201 may be identical to the platform 101 as shown in FIG. 1, and therefore its detailed description is omitted.

For the sake of clarity, only one installed virtual machine 203 having a guest operation system is shown in FIG. 2. Application programs can be installed in the virtual machine 203. Those skilled in the art should understand that embodiments of the present invention are also applicable to computer systems with more than one virtual machine installed.

In a state where the virtual machine 203 stops running, the virtual machine 203 exists in the form of an image. For example, virtual machine images may present as virtual hard disk files stored and managed in the file system of the hypervisor 202. A virtual hard disk file includes the file system of the virtual machine 203. However, because virtual hard disk files are usually stored in the format of a binary compression file, the file system of the virtual machine 203 is not directly accessible from the file system of the hypervisor 202. The virtual machine 203 may have more than one image. For example, when there are guest operation systems, database applications and various agents in the file system of the virtual machine 203, the virtual machine 203 may have guest operation system images, database images and agent images. Various images possessed by the virtual machine 203 are shown in FIG. 2 with images 204-1, 204-2, . . . , 204-n as examples, assuming that the image 204-2 is an agent image.

As shown in FIG. 2, the hypervisor 202 comprises an agent obtaining device 210, an agent replacing device 211 and a virtual machine starting device 212. The hypervisor 202 may start a virtual machine in response to an external command. The external command is a command input into the hypervisor 202 by a user through an input device such as keyboard, mouse or the like. For example, the hypervisor 202 may accept, via a command input interface such as the SHELL routine, an external command input by a user through a keyboard; or the hypervisor 202 may accept, via a graphic user interface, the external command input by the user through mouse operations. By specifying parameters, configuration files or other options at the time of inputting commands, generally, the following information may be provided to the hypervisor 202 through the external commands:
information 1): information identifying a virtual machine to be started (the virtual machine 203 in the present embodiment);
information 2): information identifying the storage path and the file name for the agent image of the virtual machine to be started in the file system of the hypervisor 202. For example, “AgentDiskFile=opt/myvm/disks/agentpart” represents that the storage path for the agent image is “/opt/myvm disks/”, and the file name for the agent image is “agentpart.”

For example, the above information may be provided in the manner of command line parameters or configuration files.

According to an embodiment, the hypervisor 202 may also start a corresponding virtual machine at a time scheduled in advance or in response to a predetermined event. Accordingly, the hypervisor 202 can also provide the above information, for example, through configuration files, internal messages or the like.

When a virtual machine is to be started by the hypervisor 202, the agent obtaining device 210 can obtain an instruction to start the virtual machine. The agent obtaining device 210 obtains a file for implementing an agent in response to the instruction to start the virtual machine. For example, it is possible to obtain the file from a predetermined location where the file for implementing the agent is stored. According to an embodiment of the present invention, this predetermined location may be a location within the computer system 200, for example, a location in a storage device of the computer system 200 that can be accessed by the hypervisor 202. According to an embodiment of the present invention, this predetermined location may be a location external to the computer system 200, for example, a location in a remote storage server that can be accessed by the computer system 200. The file for implementing the agent may be found according to a virtual machine identifier and information for indicating whether the file is of agent type in the information 1), above.

The file for implementing the agent, i.e., the file for implementing the agent configured for the virtual machine, refers to an executable code file which can be executed in a guest operation system environment of the virtual machine to complete a certain kind of agent functions. The file for implementing the agent may also include data files required for the execution of the agent. The file for implementing the agent is stored in the file system of the virtual machine so that it can be accessed by the virtual machine. The virtual machine can load and execute corresponding agents according to these files. Such files can be prepared for the agents configured for the virtual machine at a storage location. These files are usually more recently updated versions than existing files.

The agent replacing device 211 is configured to store the file obtained by the agent obtaining device 210 to a specified location in the file system of the virtual machine. According to an embodiment of the present invention, the obtained file is stored in an overwrite storage manner to replace the existing file at the specified location.

The obtained file may take various forms. For example, the file for implementing the agent may take the form of a virtual machine image. In that case, the agent replacing device 211 may directly replace the agent image indicated by the information 2), above, with the obtained agent image, to carry out the storage of the obtained file at the specified location in the file system of the virtual machine.

The file for implementing the agent may also take the form of an executable code file and data file (if available). In that case, the agent replacing device 211 may comprise a linking device for mounting the image of the virtual machine specified in the information 2), above, to the file system of the hypervisor 202 to enable presenting the agent image as a file system, so that the obtained file for implementing the agent can be stored at a specified location in the file system of the virtual machine. For example, in a file system based on UNIX, it is possible to perform the mounting through the “mount” command. The specified location may be determined through various ways. The specified location may be a conventional location, for example, a location determined from the information 1) or the information 2) according to predetermined rules. In an example, the location may be “agent/”+“virtual machine identifier_agent”, wherein “virtual machine identifier” can be obtained from the information 1). The specified location may also be predetermined. For example, it is possible to specify a dedicated and fixed location (i.e., path) as the location. Alternatively, the specified location may also be provided through command line parameters, configuration files or internal messages.

Because the agent image is mounted as a sub-file system on the file system of the hypervisor 202, the file system of the hypervisor 202 can reflect the storage of the file for implementing the agent to the agent image. For example, when the file in the sub-file system corresponding to the agent image is replaced, the file system of the hypervisor 202 will update the agent image correspondingly. This updating may be performed in real time, or may be performed upon unmounting the sub-file system corresponding to the agent image. Because the hypervisor 202 is usually not required to access the file system of the agent image again after storing the file for implementing the agent, it is possible to unmount the image after storing the file.

The virtual machine starting device 212 is configured to start the virtual machine. In general, the virtual machine starting device 212 starts the virtual machine in response to completion of the storing by the agent replacing device 211, i.e., when the agent obtaining device 210 completes the obtaining of the file for implementing the agent of the virtual machine to be started, and the agent replacing device 211 completes the storing of the file for implementing the agent of the virtual machine to be started.

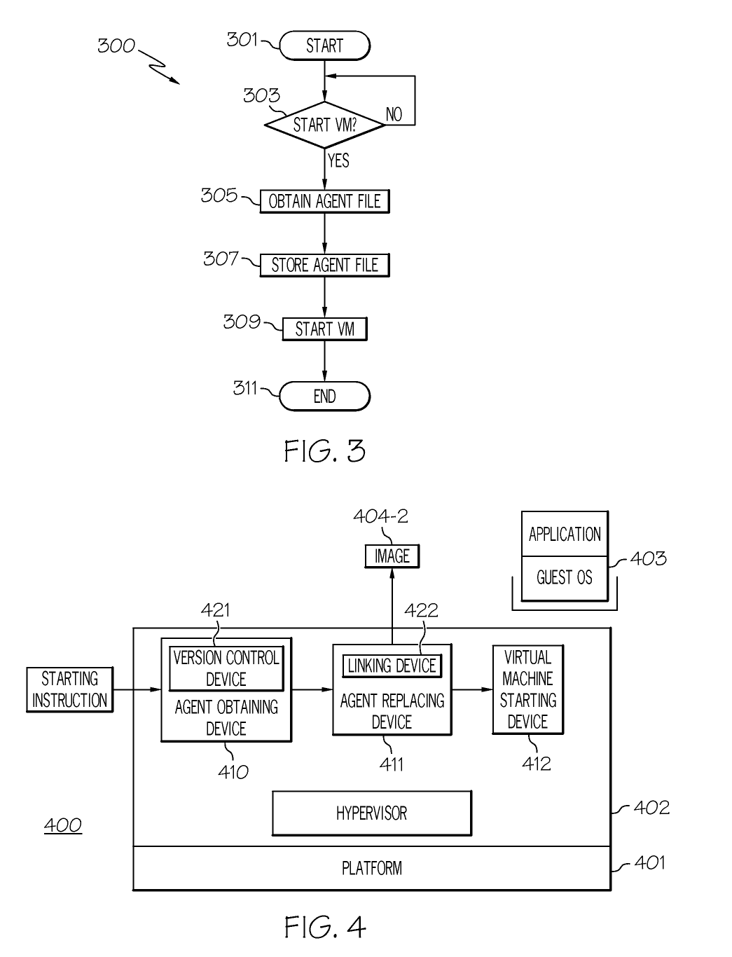

FIG. 3 is a flow chart showing a method 300 of updating an agent in a virtual machine of a computer system according to an embodiment of the present invention. The method 300 is implemented in the platform virtualization layer.

As shown in FIG. 3, the method starts from step 301. At step 303, it is determined whether there is an instruction of starting a virtual machine. It is possible to start the virtual machine in response to an external command. The external command may be as described above in connection with the embodiment of FIG. 2. By specifying parameters, configuration files or other options at time of inputting commands, usually, it is possible to provide the information 1) and the information 2) described above in connection with the embodiment of FIG. 2 to the platform virtualization layer through external commands.

It is possible to start a corresponding virtual machine at a time scheduled in advance or in response to a predetermined event. Accordingly, the platform virtualization layer can also provide the above information, for example, through configuration files, internal messages, or the like.

When a virtual machine is to be started, at step 303, an instruction for starting the virtual machine can be obtained, and accordingly, step 305 is executed. If no instruction of starting virtual machine is detected, the execution of step 303 continues.

At step 305, a file for implementing an agent configured for the virtual machine is obtained in response to the instruction of starting the virtual machine. It is possible to obtain the file for implementing the agent configured for the virtual machine from a predetermined location. According to an embodiment of the present invention, this predetermined location may be within the computer system where the platform virtualization layer resides, for example, a location in a storage device of the computer system that can be accessed by the platform virtualization layer. According to an embodiment of the present invention, this predetermined location may be a location external to the computer system where the platform virtualization layer resides, for example, a location in a remote storage server that can be accessed by the platform virtualization layer. The file for implementing the agent configured for the virtual machine may be found according to a virtual machine identifier and information for indicating whether the file is of agent type in the information 1).

At step 307, the file obtained at step 305 is stored at a specified location in the file system of the virtual machine. According to an embodiment of the present invention, the obtained file is stored in an overwrite storage manner to replace the existing file at the specified location.

The obtained file may take various forms. For example, the file for implementing the agent may take a form of virtual machine image. In that case, the agent replacing device 211 may directly replace the agent image indicated by the information 2) with the obtained agent image, to carry out the storage of the obtained file at the specified location in the file system of the virtual machine.

In a further embodiment, the file for implementing the agent may also take a form of executable code file and data file (if available). In that case, step 307 may include mounting the image of the virtual machine specified in the information 2) to the platform virtualization layer 202 of the file system to enable presenting the agent image as a file system, so that the obtained file for implementing the agent can be stored at the specified location in the file system of the virtual machine. The specified location may be determined through various ways. For example, the specified location may be a conventional location, such as a location determined from the information 1) or the information 2) according to predetermined rules. In an example, the location may be “agent/”+ “virtual machine identifier_agent”, wherein “virtual machine identifier” can be obtained from the information 1). The specified location may also be predetermined. For example, it is possible to specify a dedicated and fixed location (i.e., path) as the location. Alternatively, the specified location may also be provided through command line parameters, configuration files or internal messages.

Because the agent image is mounted as a sub-file system on the file system of the platform virtualization layer, the file system of the platform virtualization layer can reflect the storage of the file for implementing the agent to the agent image. For example, when the file in the sub-file system corresponding to the agent image is replaced, the file system of the platform virtualization layer will update the agent image correspondingly. This updating may be performed in real time, or may be performed upon unmounting the sub-file system corresponding to the agent image. Because the platform virtualization layer is usually not required to again access the file system of the agent image after storing the file for implementing the agent, it is possible to unmount the image after storing the file.

At step 309, the virtual machine is started. In general, step 309 is executed in response to the completion of the storing at step 307, i.e., when the obtaining and the storing of the file for implementing the agent of the virtual machine to be started are completed. The method ends at step 311.

According to the embodiments described in connection with FIG. 2 and FIG. 3, the updating of the agent is completed by the platform virtualization layer after deciding to start the virtual machine and before the virtual machine is started, to ensure that the agent is the most updated when the virtual machine runs. Further, the function of agent updating is configured in the platform virtualization layer, to avoid embedding the function into application programs or agents, thereby simplifying the maintenance and the updating for the function itself

In the embodiments described above, upon starting the virtual machine, these files are obtained from the location usually saving files of the up to date agents and are stored at the agent image of the virtual machine, so as to update the agents (if there is any agent with more updated version). However, if the version of the agents stored at the location saving files of the up to date agents is not more updated than that of the agents in the agent image, or if the version of at least a portion of the agents is not more updated, it is not necessary to obtain and store the files of such agents.

In a further embodiment, it is also possible to obtain information for identifying an agent to be updated in response to the instruction of starting the virtual machine. For example, information “AgentID=myvm_agent” defines the identifier of an agent as “myvm_agent”. It can be understood that it is possible to define information for more than one agent. Through the agent obtaining device 210 or at step 305, it is possible to only obtain files for implementing the identified agents according to the information for identifying the agents. Through the agent replacing device 211 or at step 307, it is possible to store the obtained files at the specified locations in the file system of the virtual machine.

FIG. 4 schematically shows the structure of a computer system 400 according to an embodiment of the present invention. As shown in FIG. 4, the computer system 400 comprises a hypervisor 402 for providing platform virtualization. Further, to facilitate understanding, FIG. 4 also shows a platform 401 of the computer system 400. The platform 401 may be identical to the platform 201 as shown in FIG. 2. Because it is irrelevant to the purpose of the embodiments of the present invention, its detailed description is omitted.

For the sake of clarity, only one installed virtual machine 403 having a guest operation system is shown in FIG. 4. Application programs can be installed in the virtual machine 403. It can be seen from the description herein that the embodiments of the present invention are also applicable to computer systems having more than one virtual machine installed thereon. An image 404-2 is an agent image of the virtual machine 403.

As shown in FIG. 4, the hypervisor 402 comprises an agent obtaining device 410, an agent replacing device 411 and a virtual machine starting device 412. The hypervisor 402 can start the virtual machine in response to an external command. The hypervisor 402 may also start a corresponding virtual machine at a time scheduled in advance or in response to a predetermined event. In addition to the information 1) and 2), it is also possible to obtain the following information in response to the instruction of starting the virtual machine: 3) information for identifying agents configured in the virtual machine to be started and versions thereof. For example, information “AgentID=myvm_agent” for representing an agent identifier defines the identifier of an agent as “myvm_agent”. Information “AgentVersion=1.1.2” for representing a version defines the version of an agent with an agent identifier “myvm_agent” as “1.1.2”. Each pair of agent identifier and version corresponds to one agent. It can be understood that it is possible to define information for more than one agent.

When a virtual machine is to be started by the hypervisor 402, the agent obtaining device 410 can obtain an instruction of starting the virtual machine. The agent obtaining device 410 obtains a file for implementing an agent in response to the instruction of starting the virtual machine. The file for implementing the agent of the virtual machine may be stored at a predetermined location. This location may be within the computer system 400, for example, a location in a storage device of the computer system 400 that can be accessed by the hypervisor 402, or a location external to the computer system 400, for example, a location in a remote storage server that can be accessed by the computer system 400. The file for implementing the agent of the virtual machine may be found according to a virtual machine identifier in the information 1) and the agent identifier in the information 3).

The agent obtaining device 410 comprises a version control device 421 which obtains the file with the more updated version by enabling a version comparison between a file for implementing the agent in the file system of the virtual machine to be started and the file to be obtained for implementing the agent. The version control device 421 may enable the version comparison through various ways. For example, the version control device 421 may obtain the pair of agent identifier and version in the information 3) according to the instruction for starting the virtual machine. For each pair of agent identifier and version in the information 3), the version control device 421 obtains the version of the agent indicated by the agent identifier from the predetermined location for storing the file for implementing the agent, and compares the obtained version with that in the pair of agent identifier and version. If the obtained version is more updated than the version in the pair of agent identifier and version, the file for implementing the indicated agent is obtained from the predetermined location. Further or alternatively, if the obtained version is not more updated than the version in the pair of agent identifier and version, this pair of agent identifier and version may be ignored, and the processing continues to the next pair of agent identifier and version.

For another example, if the predetermined location for storing the file for implementing the agent is a storage server, the version control device 421 may obtain the pair of agent identifier and version in the information 3) according to the instruction for starting the virtual machine. For each pair of agent identifier and version in the information 3), the version control device 421 transmits an acquisition request including the agent identifier and the version pair to the storage server. The storage server compares the version of the locally stored agent indicated by the agent identifier with the version included in the acquisition request. If the version of the agent locally stored in the storage server and indicated by the agent identifier is more updated than the version included in the acquisition request, the file for implementing the agent is returned to the agent obtaining device 410, and the agent obtaining device 410 receives the file for implementing the agent returned by the storage server in response to the acquisition request. Further or alternatively, if the version of the agent locally stored in the storage server and indicated by the agent identifier is not more updated than the version included in the acquisition request, corresponding information is returned, and the version control device 421 ignores this pair of agent identifier and version according to the returned information and continues to process the next pair of agent identifier and version.

The file for implementing an agent of the virtual machine refers to the executable code file and data file (if available) relating to the agent. The virtual machine can load and execute corresponding agents according to these files. The files with up to date versions can be prepared for the agents configured for the virtual machine at a storage location.

In response to the event that the agent obtaining device 410 obtains the file, the agent replacing device 411 stores (in an overwrite storage manner) the obtained file to a specified location in the file system of the virtual machine. The obtained file may take various forms. For example, the file for implementing the agent may take the form of virtual machine image. In that case, the agent replacing device 411 may directly replace the agent image indicated by the information 2) with the obtained agent image, to carry out the storage of the obtained file at the specified location in the file system of the virtual machine.

In a further embodiment, the file for implementing the agent may also take the form of an executable code file and data file (if available). In that case, the agent replacing device 411 may comprise a linking device 422 for mounting the image of the virtual machine specified in the information 2) to the file system of the hypervisor 402 to enable presenting the agent image as a file system, so that the obtained file for implementing the agent can be stored at the specified location in the file system of the virtual machine. For example, in a file system based on UNIX, it is possible to perform the mounting through the “mount” command. The specified location may be determined through various ways. For example, the specified location may be a conventional location, such as a location determined from the information 1) or the information 2) according to predetermined rules. In an example, the location may be “agent/” +“virtual machine identifier_agent”, wherein “virtual machine identifier” can be obtained from the information 1). The specified location may also be predetermined. For example, it is possible to specify a dedicated and fixed location (i.e., path) as the location. Alternatively, the specified location may also be provided through command line parameters, configuration files or internal messages.

Because the agent image is mounted as a sub-file system on the file system of the hypervisor 402, the file system of the hypervisor 402 can reflect the storage of the file for implementing the agent to the agent image. For example, when the file in the sub-file system corresponding to the agent image is replaced, the file system of the hypervisor 402 will update the agent image correspondingly. This updating may be performed in real time, or may be performed upon unmounting the sub-file system corresponding to the agent image.

The virtual machine starting device 412 is configured to start the virtual machine. In general, the virtual machine starting device 412 starts the virtual machine in response to the completion of the storing by the agent replacing device 411, i.e., when the agent obtaining device 410 completes the obtaining of the file for implementing the agent of the virtual machine to be started and the agent replacing device 411 completes the storing of the file for implementing the agent of the virtual machine to be started.

In a further embodiment, the virtual machine starting device 412 starts the virtual machine in case the agent obtaining device does not obtain the file with more updated version due to determining, through the version comparison, that the version of any file to be obtained for implementing the agent is not more updated than that of the file for implementing the agent in the file system of the virtual machine. For example, in the embodiment where the version of the agent indicated by the agent identifier in the pair of agent identifier and version is obtained from the predetermined location for storing the file for implementing the agent, for all the pairs of agent identifier and version, if the obtained version is not more updated than that in the pair of agent identifier and version, the agent obtaining device does not obtain the file with more updated version. For another example, in the embodiment where the acquisition request is transmitted to the storage server for storing the file for implementing the agent, for all the pairs of agent identifier and version, if the version of the file for implementing the agent locally stored by the storage server is not more updated than that in the pair of agent identifier and version, the agent obtaining device does not obtain the file with more updated version.

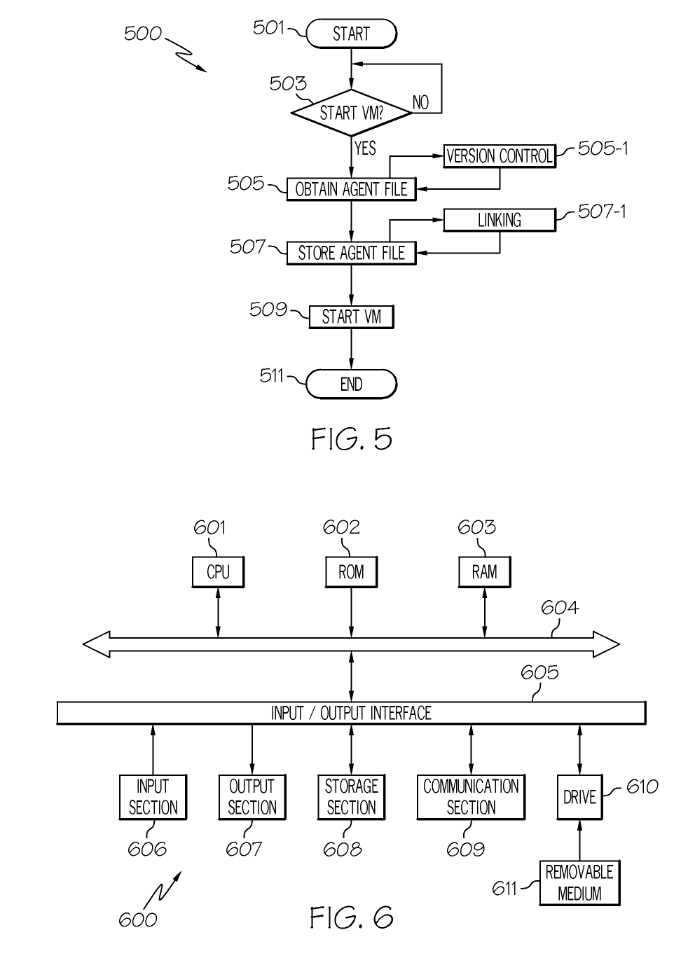

FIG. 5 is a flow chart showing a method 500 of updating an agent in a virtual machine of a computer system according to an embodiment of the present invention. The method 500 is implemented in the platform virtualization layer. As shown in FIG. 5, the method starts at step 501.

At step 503, it is detected whether there is an instruction of starting a virtual machine. It is possible to start the virtual machine in response to an external command. It is also possible to start a corresponding virtual machine at a time scheduled in advance or in response to a predetermined event. In addition to the information 1) and 2), it is also possible to obtain the information 3) described above in connection with FIG. 4, in response to the instruction of starting the virtual machine.

When a virtual machine is to be started, at step 503, an instruction of starting the virtual machine can be obtained, and accordingly, step 505 is executed. If no instruction of starting a virtual machine is detected, the execution of step 503 continues.

At step 505, a file for implementing an agent configured for the virtual machine is obtained in response to the instruction of starting the virtual machine. The file for implementing the agent of the virtual machine may be stored at a predetermined location. This location may be a location within the computer system, for example, a location in a storage device of the computer system that can be accessed by the platform virtualization layer, or may be a location external to the computer system, for example, a location in a remote storage server that can be accessed by the platform virtualization layer. The file for implementing the agent of the virtual machine may be found according to a virtual machine identifier in the information 1) and the agent identifier in the information 3).

The step 505 comprises a sub-step 505-1. At sub-step 505-1, the obtained file can have an up-to-date version by enabling a version comparison between a file for implementing the agent in the file system of the virtual machine to be started and the file to be obtained for implementing the agent.

It is possible to enable the version comparison through various ways. For example, it is possible to obtain the pair of agent identifier and version in the information 3) according to the instruction of starting the virtual machine. For each pair of agent identifier and version in the information 3), it is possible to obtain the version of the agent indicated by the agent identifier from the predetermined location for storing the file for implementing the agent, and compare the obtained version with that in the pair of agent identifier and version. If the obtained version is more updated than the version in the pair of agent identifier and version, the file for implementing the indicated agent is obtained from the predetermined location. Further or alternatively, if the obtained version is not more updated than the version in the pair of agent identifier and version, this pair of agent identifier and version may be ignored, and the processing continues to the next pair of agent identifier and version.

For another example, if the predetermined location for storing the file for implementing the agent is a storage server, it is possible to obtain the pair of agent identifier and version in the information 3) according to the instruction for starting the virtual machine. For each pair of agent identifier and version in the information 3), it is possible to transmit an acquisition request including the agent identifier and the version in the pair of agent identifier and version to the storage server. The storage server compares the version of the locally stored agent indicated by the agent identifier with the version included in the acquisition request. If the version of the agent locally stored in the storage server and indicated by the agent identifier is more updated than the version included in the acquisition request, the file for implementing the agent is returned to the platform virtualization layer, and the platform virtualization layer receives the file for implementing the agent returned by the storage server in response to the acquisition request. Further or alternatively, if the version of the agent locally stored in the storage server and indicated by the agent identifier is not more updated than the version included in the acquisition request, corresponding information is returned, and the platform virtualization layer ignores this pair of agent identifier and version according to the returned information and continues to process the next pair of agent identifier and version.

The file for implementing an agent of the virtual machine refers to executable code file and data file (if available) relating to the agent. The virtual machine can load and execute corresponding agents according to these files. The files with up-to-date versions can be prepared for the agents configured for the virtual machine at a storage location.

At step 507, the file obtained at step 505 is stored at a specified location in the file system of the virtual machine. According to an embodiment of the present invention, the obtained file is stored in an overwrite storage manner to replace the existing file at the specified location.

The obtained file may take various forms. For example, the file for implementing the agent may take the form of a virtual machine image. In that case, the agent replacing device 211 may directly replace the agent image indicated by the information 2) with the obtained agent image, to carry out the storage of the obtained file at the specified location in the file system of the virtual machine.

In a further embodiment, the file for implementing the agent may also take a form of executable code file and data file (if available). In that case, step 507 may comprise a sub-step 507-1. At sub-step 507-1, the image of the virtual machine specified in the information 2) is mounted to the platform virtualization layer of the file system to enable presenting the agent image as a file system, so that the obtained file for implementing the agent can be stored at the specified location in the file system of the virtual machine. The specified location may be determined through various ways. The specified location may be a conventional location, for example, a location determined from the information 1) or the information 2) according to predetermined rules. In an example, the location may be “agent/” +“virtual machine identifier_agent”, wherein “virtual machine identifier” can be obtained from the information 1). The specified location may also be predetermined. For example, it is possible to specify a dedicated and fixed location (i.e., path) as the location. Alternatively, the specified location may also be provided through command line parameters, configuration files or internal messages.

Because the agent image is mounted as a sub-file system on the file system of the platform virtualization layer, the file system of the platform virtualization layer can reflect the storage of the file for implementing the agent to the agent image. For example, when the file in the sub-file system corresponding to the agent image is replaced, the file system of the platform virtualization layer will update the agent image correspondingly. This updating may be performed in real time, or may be performed upon unmounting the sub-file system corresponding to the agent image. Because the platform virtualization layer is usually not required to access the file system of the agent image again after storing the file for implementing the agent, it is possible to unmount the image after storing the file.

At step 509, the virtual machine is started. In general, step 509 is executed in response to the completion of the storing at step 507, i.e., when the obtaining and the storing of the file for implementing the agent of the virtual machine to be started is completed. The method ends at step 511.

In a further embodiment, the virtual machine is started in case the file with a more updated version is not obtained at step 505 due to determining, through the version comparison, that the version of any file to be obtained for implementing the agent is not more updated than that of the file for implementing the agent in the file system of the virtual machine. For example, in the embodiment where the version of the agent indicated by the agent identifier in the pair of agent identifier and version is obtained from the predetermined location for storing the file for implementing the agent, for all the pairs of agent identifier and version, if the obtained version is not more updated than that in the pair of agent identifier and version, the file with more updated version is not obtained at step 505. For another example, in the embodiment where the acquisition request is transmitted to the storage server for storing the file for implementing the agent, for all the pairs of agent identifier and version, if the version of the file for implementing the agent locally stored by the storage server is not more updated than that in the pair of agent identifier and version, the file with more updated version is not obtained at step 505.

According to the embodiments described in connection with FIG. 4 and FIG. 5, because it is able to perform an actual update to the agent with its version updated, unnecessary updates can be avoided, thereby improving the efficiency of agent update and virtual machine start.

In the embodiments described in the above, the agent obtaining device may comprise a buffering device for temporarily storing the obtained file in the file system of the hypervisor before storing the obtained file at the specified location in the file system of the virtual machine. Therefore, the agent replacing device is able to fetch the temporarily stored file from the file system of the hypervisor and store the file to the file system of the virtual machine. Accordingly, in the embodiments described above, the obtaining step may comprise temporarily storing the obtained file in the file system of the platform virtualization layer before storing the obtained file at the specified location in the file system of the virtual machine. Therefore, the storing step can fetch the temporarily stored file from the file system of the platform virtualization layer and store the file to the file system of the virtual machine. Information indicating the location for the temporary storage may be included in the information that can be obtained in response to the instruction of starting the virtual machine. For example, information “LocalAgentHome=/tmp agent/myvm_agent” defines a temporary storage location as “/tmp/agent/myvm_agent”. Alternatively, it is also possible to define a fixed temporary storage location. The function of temporary storage enables buffering the file for implementing the agent in the platform virtualization layer, thereby allowing a greater degree of freedom in selecting the timing when the file for implementing the agent is stored at the file system of the virtual machine. For example, with respect to an agent, it is possible to store all the files for implementing the agent to the file system of the virtual machine after these files are obtained, thereby providing updating reliability and security. For another example, if a plurality of agents are to be updated, it is possible to store all the files for implementing all the agents to the file system of the virtual machine after these files are obtained, thereby providing updated reliability and security.

In the embodiments above, it was assumed that the agent can operate after the file for implementing the agent is stored at the file system of the virtual machine and the virtual machine starts. However, some agents are required to perform setting and registering operation after their files are stored in the file system of the virtual machine, so as to be able to operate. This setting and registering operation is known as activating.

In a further embodiment of the computer system described above, the hypervisor may also comprise an agent activating device. The agent activating device activates the agent to which the stored file corresponds, i.e., the updated agent, in response to the start of the virtual machine. Information required for activating may be included in the information that can be obtained in response to the instruction of starting the virtual machine. For example, information “AgentHome=/agent/myvm_agent” indicates a storage location “/agent/myvm_agent” where the agent to be activated is stored in the file system of the virtual machine, and information “AgentActivationCommand=/agent/myvm_agent/activate_agent.sh” indicates an activating script “/agent/myvm_agent/activate_agent.sh” required for activating the agent. Further, information “functions={f1, f2, f3, . . . , fn}” defines a management function set (relating to registration) for the agent to be activated. The agent activating device can obtain the information about which agent is required to be activated due to being updated from the agent replacing device. Accordingly, in a further embodiment of the methods described in the above, it may also comprise activating the agent to which the stored file corresponds in response to the start of the virtual machine.

Although the illustrations are provided with respect to only one agent image in the previous embodiments, it is possible to specify more than one agent image in the information 2). Accordingly, each pair of agent identifier and version is associated with a corresponding agent image in the information 3). The linking device may mount the associated agent image according to the agent corresponding to the obtained file, so that the file can be stored in the associated agent image.

According to an embodiment of the present invention, the agent image of the virtual machine is mounted in the file system of the platform virtualization layer, so that the platform virtualization layer can access the content relating to the agent in the file system of the virtual machine. This makes it possible to simply input the file for implementing the agent, instead of converting the file for implementing the agent into the form of an image in preparing the file. Because agent images of different virtual machines may have different agent configurations, even the file for implementing the agent and other files are included in one image, the omission of the operation of converting to an image also means it is unnecessary to do extra and troublesome work to study the composition of the image to perform the conversion.

FIG. 6 is a block diagram showing the exemplary structure of a physical computer for implementing an embodiment of the present invention. In FIG. 6, a central processing unit (CPU) 601 performs various processes in accordance with a program stored in a read only memory (ROM) 602 or a program loaded from a storage section 608 to a random access memory (RAM) 603. In the RAM 603, data required when the CPU 601 performs the various processes, or the like, is also stored as required. The CPU 601, the ROM 602 and the RAM 603 are connected to one another via a bus 604. An input/output interface 605 is also connected to the bus 604.

The following components are connected to input/output interface 605: an input section 606, including a keyboard, a mouse, or the like; an output section 607, including a display such as a cathode ray tube (CRT), a liquid crystal display (LCD), or the like, and a loudspeaker or the like; the storage section 608, including a hard disk or the like; and a communication section 609, including a network interface card such as a LAN card, a modem, or the like. The communication section 609 performs a communication process via a network such as the Internet.

A drive 610 is also connected to the input/output interface 605, as required. A removable medium 611, such as a magnetic disk, an optical disk, a magneto-optical disk, a semiconductor memory, or the like, is mounted on the drive 610 as required, so that a computer program read, therefrom, is installed into the storage section 608 as required.

In the case where the above described steps and processes are implemented by software, the program that constitutes the software is installed from the network such as the Internet or the storage medium, such as the removable medium 611.

One skilled in the art should note that this storage medium is not limited to the removable medium 611 having the program stored therein as illustrated in FIG. 6, which is delivered separately from the approach for providing the program to the user. Examples of the removable medium 611 include the magnetic disk, the optical disk (including a compact disk-read only memory (CD-ROM) and a digital versatile disk (DVD)), the magneto-optical disk (including a mini-disk (MD)), and the semiconductor memory. Alternatively, the storage medium may be the ROM 602, the hard disk contained in the storage section 608, or the like, which has programs stored therein.

Having thus described the invention of the present application in detail and by reference to embodiments thereof, it will be apparent that modifications and variations are possible without departing from the scope of the invention defined in the appended claims.

What is claimed is:

1. A method of starting a virtual machine in a hypervisor of a computer system, comprising:
obtaining a first file for implementing a first agent of the virtual machine with a processor, in response to a command to start the virtual machine;
storing said obtained first file to a specified memory location in a virtual machine file system; and
starting said virtual machine.

2. The method of claim 1, wherein starting the virtual machine comprises starting the virtual machine when said obtained first file is stored.

3. The method of claim 1, wherein obtaining said first file for implementing said first agent of the virtual machine comprises obtaining a more updated file version by enabling a version comparison between a second file for implementing a second agent in said virtual machine file system and said first file to be obtained for implementing said first agent.

4. The method of claim 3, wherein said obtaining a more updated file version comprises:
obtaining a first pair comprising a first agent identifier and a first version from said command;
obtaining a second pair comprising a second agent identifier and a second version from a predetermined location where said second file for implementing said second agent is stored; comparing said first version with said second version; and
when said second version is more recently updated than said first version, obtaining said second file for implementing said second agent from said predetermined location.

5. The method of claim 4, wherein storing an obtained file at said specified location in said virtual machine file system comprises mounting an image of said virtual machine to a file system of the hypervisor to enable storing the obtained file at said specified location in said virtual machine file system.

6. The method of claim 5, further comprising temporarily storing said obtained file in said hypervisor file system before storing said obtained file at said specified location in said virtual machine file system.

7. The method of claim 6, further comprising activating an agent to which a stored file corresponds, in response to a start of said virtual machine.
